(19) United States
(12) Patent Application Publication
(10) Pub. No.: US 2018/0141188 A1
(43) Pub. Date: May 24, 2018

(54) FRICTION RATCHET WRENCH

(71) Applicant: HANGZHOU LI ER YI INDUSTRIAL CO., LTD., Hangzhou (CN)

(72) Inventor: Yongfei LAI, Hangzhou (CN)

(73) Assignee: HANGZHOU LI ER YI INDUSTRIAL CO., LTD., Hangzhou (CN)

(21) Appl. No.: 15/603,298

(22) Filed: May 23, 2017

(30) Foreign Application Priority Data
Nov. 23, 2016 (CN) 201611041655.9

(51) Int. Cl. B25B 13/46; B25B 23/00

(52) U.S. Cl. CPC B25B 13/462; B25B 23/0035

(57) ABSTRACT

A friction ratchet wrench suitable for being connected with a socket, comprising an outer shell with a regular polygonal friction cavity, a retainer rotatablely disposed in the friction cavity and a friction cylinder inside the retainer, wherein a joint connecting with the socket is disposed in the friction cylinder, friction elements are disposed at the peak angles of the friction cavity of the corresponding regular polygon in a rim of the retainer, and a toggle element drives the retainer to rotate in the friction cavity and makes an outside of the friction elements of the retainer cling to outer friction surface of the friction cavity and an inside of the friction elements cling to friction cylinder in the retainer.

### CROSS-REFERENCE TO RELATED APPLICATIONS

This Non-provisional application claims priorities under 35 U.S.C. § 119(a) on Patent Application No(s). 201611041655.9, filed in People's Republic of China on Nov. 23, 2016, the entire contents of which are hereby incorporated by reference.

### BACKGROUND OF THE INVENTION

### Field of the Invention

This invention relates to a manual hardware tool and, more particularly, relates to a friction ratchet wrench.

### Description of the Related Art

A wrench is a common hardware tool, which is utilized in assembling and disassembling hardware joints, such as screws, nuts, bolts and so on. Various types of wrenches are invented to meet the demand of different occasions, wherein a ratchet wrench is a special wrench to satisfy the utilization in a narrow space like automobile repair. The basic construction of the ratchet wrench includes a handle and a rotating socket with a rotating cavity connected at the end of the handle, wherein a rotator is disposed in the rotating socket, a joint capable of being connected with a nut, a screwhead, or a connecting hole in a socket of a socket wrench is disposed on the rotator, and a ratchet-pawl structure is disposed between the rotator and a rotating cavity of the rotating socket. When the ratchet wrench is used, first the joint of the rotator is connected to the nut, the screwhead, or the connecting hole in a socket of a socket wrench, then the handle can be rotated in a forward direction, and at this moment the ratchet-pawl mechanism is working. Thus the screw and the nut can be rotated in the forward direction by the rotation of the rotating socket. Then we can rotate the wrench in reverse, as the working of the ratchet-pawl, at this moment the rotating socket cannot provide a reversed torque for the rotator, and thus idling is generated between the rotating socket and the rotator. The screw and the nut can be tightened after multiple rotation in both directions of the handle, while in the tightening process, the joint of the rotator does not need to be departed from the screwhead or the nut, which brings much convenience to the disassembly of the screws, nuts, etc.

For example, a disclosed Chinese patent document entitled “Ratchet Wrench” with the Publication No. CN203600132U, comprising a ratchet wrench main body, a ratchet, a lockpin, a pin, and a spring. The ratchet wrench further comprises two grease nipples, correspondingly the first grease nipple and the second grease nipple, a channel inside the two grease nipple run through the grease nipple from the top to the bottom of the grease nipple, a thread is disposed on the bottom thread, the grease nipple is connected with the main of the ratchet wrench, a channel is disposed inside the main of the ratchet wrench, a spring and a lockpin are disposed in order from inside to outside in the channel by adding two grease nipples, the ratchet wrench solve the above difficulty of adding the lubricating oil effectively, the convenience of adding the lubricating oil unsure the lubrication of the lockpin in moving and prevent the ratchet wrench from locking, and extend the service life of the ratchet wrench.

However, the conventional ratchet wrench still has following problems. As the pawl in the ratchet wrench is the element subject to direct stress, in other words, the torque of the wrench is provided by the force of the pawl, to decrease the scale of the ratchet wrench as much as possible, the scale of the ratchet-pawl thereof would be limited strictly, therefore the maximum torque transmitted by the ratchet wrench is limited, once an overload occurs during using, the damage of the ratchet wrench is easily to occur; in addition, in each rotating of the wrench, an impulse is generated between the pawl and the ratchet, which shorten the service life of the wrench, and for small amounts of phenomenon of idling exists in the wrench, the efficiency of the wrench will be reduced; as the ratchet wrench is mainly utilized in some narrow space, if only increasing the scale of the ratchet-pawl, the performance of the ratchet wrench will be strongly influenced. In addition, as the working condition of the ratchet wrench relatively bad, therefore, after certain period of using, the phenomenon of poor operation flexibility of the pawl inside is easy to occur, which leads to the idling of the wrench.

### BRIEF SUMMARY OF THE INVENTION

The objective of this invention is to solve the technical problem of low strength, short service time, and generated idling during using in the prior art. This invention provides a friction ratchet wrench, which can avoid the wrench to idle and observably improve the structural strength of the wrench without increasing the size thereof, thereby extending service life effectively.

To achieve the objective above, this invention provides the following technical solution.

A friction ratchet wrench, suitable for connecting with a socket, the friction ratchet wrench comprising:

an outer shell, having a regular polygonal friction cavity, every side surface of the friction cavity constituting an outer friction surface;

a retainer, rotatablely located inside the friction cavity, wherein friction elements are disposed at periphery of the retainer corresponding to peak angles of the regular polygonal friction cavity;

a friction cylinder, located inside the retainer, wherein a joint integrally extending along an axial direction and capable of being connected with the socket is disposed on the friction cylinder; and

a toggle element, capable of driving the retainer to rotate in the friction cavity, so that outer sides of the friction elements on the retainer are abutted against the outer friction surface of the friction cavity and inner sides of the friction elements are abutted against the friction cylinder located inside the retainer;

wherein when the outer shell rotates in a direction opposite to a rotating direction of the retainer, the outer shell is able to drive the friction cylinder to rotate depending on friction force between the friction elements and the friction force between the friction elements and the friction cylinder, and further to drive the joint to rotate.

The friction ratchet wrench in this invention needs to be used with an conventional socket, a polygonal socket-connection hole which connecting with the nut and the bolt head in one end of the socket, a square connection hole connecting with the wrench in the other end, the socket-connection hole is commonly formed by two concentric hexagonal holes mutually staggered at 30°. As the friction elements of the invention are located in the annular cavity formed by the friction cavity of the regular polygon and the cylindrical surface of the friction cylinder, the interval between the friction cavity and the friction cylinder has the maximum value at the peak angles of the corresponding friction cavity and the minimum value at the middle place of the outer friction surface. When the bolt is needed to be tighten or disassemble, we can cover the socket-connection hole of the socket on the bolt head or the nut first, then toggle the toggle element to make the retainer rotate in the friction cavity, thus the friction elements in the retainer rotates from the corresponding position of the peak angles of the friction cavity to the position of the outer friction surface of the friction cavity pressing close to, the inside of the friction elements presses close to the circumference surface of the friction cylinder, and the outer shell can be rotated in the reversal direction of the retainer, which makes the friction elements moving towards the side where the interval of the friction cavity and the friction cylinder is relatively small, in other words, friction force is generated by the pressing between the outer friction surface of the outer shell and the friction elements, and between the friction elements and the friction cylinder, which drives the friction cylinder to rotate and in further drive the socket to rotate by the joint, and the bolt is tighten or loosen; when the outer shell is rotated to a certain angle. we can rotate the outer shell in reverse, which makes the friction elements moving towards the side where the interval of the friction cavity and the friction cylinder is relatively large, thus the friction elements lose the squeezing action with the outer friction surface of the friction cavity and the friction cylinder and slips, which ensures the outer shell freely rotate in reverse; then rotate the outer shell in forward direction again, the bolt can be tighten or loosen as described above. As the under stress element is the friction element in the invention, and what stress the friction element under is a extrusion force, it can be ensured to have a very high compressive strength, and the force that the inner friction cylinder under is also a extrusion force uniformly acting on the circumference surface thereof, while the friction cavity of the outer shell is under the radial expanding extrusion force uniformly distributed in the circumferential direction, in other words, the outer shell mainly bears a tension, thus the friction cylinder has a very large compressive strength, and the outer shell also has a very large compressive strength, therefore it helps to decrease the scale of the invention and ensure the strength and service life thereof. More especially, when we toggle the toggle element to make the retainer rotate in the friction cavity, the friction elements are respectively pressed closed to the outer friction surface and the circumference surface of the friction cylinder, therefore, when the outer shell is rotated, the joint is directly driven to rotate, when the outer shell is rotated in reverse, the friction element is not reset by the affect of spring. etc., but is driven by the rotating of the outer shell, therefore the phenomenon of idling can be effectively avoided.

Preferably, the friction cavity may be of regular hexagon, a diffusion groove may be disposed at the peak angle of the friction cavity in the outer shell, the undersurface of the diffusion groove may be a cylindrical surface extending along the depth direction of the friction cavity, two sides of the diffusion groove may be connected with the outer friction surface on both sides of the peak angle correspondingly.

The diffusion groove helps the adding of the maximum interval at the corresponding peak angle of the friction cavity between the friction cavity and the friction cylinder and the installing of the retainer and the friction elements, and in further remits the stress concentration phenomenon at the intersection of the two neighboring outer friction surfaces obviously, it improves the intensity and the service time of the outer shell, and facilitates the processing and manufacturing of the outer friction surface of the friction cavity.

Preferably, the retainer may be of circular ring, containing grooves may be disposed on an outside wall of the retainer, whose quantity may be the same as that of the outer friction surfaces of the friction cavity, the containing groove may cut through the inside wall of the retainer along the axial direction and uniformly distribute along the circumference direction, the friction elements may be of cylinder, and the axes of the friction elements may be in parallel with that of the retainer, each of the friction elements correspondingly may dispose in each containing groove, a cross section of the containing groove matches with a longitudinal section of the friction elements.

The retainer of circle shape helps its locating and rotating in the regular polygonal friction cavity and the processing and manufacturing thereof, which ensures each friction element distribute in the circumferential direction of retainer uniformly; while the radial containing groove makes the friction elements moving freely along the radial direction, which ensures both sides in and out of the friction elements to be pressed close to the circumference surface of the friction cylinder and the outer friction surface of the friction cavity. As the cross section of the containing groove matches with the longitudinal section of the friction elements, the friction elements can be ensured to move freely along the containing groove, meanwhile the friction elements can be ensured to locate in the position of the retainer, thus multiple friction elements are pressed close to the outer friction surface and the friction cylinder reliably, which generates an enough friction force and stresses each element uniformly, so that the service life is extended in its favour.

Preferably, a reversing cavity located by the side of the friction cavity may be disposed inside the outer shell, and a rotatable reversing base may be disposed in the cavity, wherein the toggle element may comprise a scalable toggle rod is disposed on the reversing base, a locating notch may be disposed on the retainer, an end of the toggle rod may be located in the locating notch.

When the reversing base is rotated in both direction, the retainer can be driven to rotate in both direction by the toggle rod, therefore the invention can handily switch among the two work modes of tightening the bolt in forward direction and loosening the bolt in reverse direction.

Preferably, a radial engaging slot cutting through the outside wall may be disposed on the reversing base, the toggle rod may be slidingly connected in the radial engaging slot, an outer end of the toggle rod stretched out of the radial engaging slot may be located in the locating notch, a spring hole may be disposed in an inner end of the toggle rod, a telescopic compression spring may be disposed in the spring hole.

As the telescopic compression spring is mainly in the spring hole of the toggle rod, under the premise of ensuring the compact form of the invention, the length of the toggle rod is ensured to be enough, which makes for the sliding thereof in the radial engaging slot, and helps the end thereof locate in the locating notch reliably, and the length of the telescopic compression spring, which makes for enough expansion allowance for the toggle rod. More especially, the telescopic compression spring can make the end of the toggle rod tightly press against the locating notch all the time, thus the friction elements in the retainer have no interval with the outer friction surface and the friction cylinder, which effectively avoids the phenomenon of idling of the invention during work.

Preferably, a locating hole extended along the axial direction may be disposed on the upper surface of one side near the opening of the friction cavity on the reversing base, a locating spring and a locating ball may be disposed from inside to outside of the locating hole, a cover may be disposed at the opening of the friction cavity of the outer shell, two locating slots and a cambered transition groove connected the two locating slots may be disposed on an inner surface of the cover, a depth of the transition groove may be less than that of the locating slot, wherein the locating ball may be limited in the first locating slot, when reversing base is rotated, the locating ball may move to the second locating slot along the transition groove.

When the reversing base is rotated to make the retainer rotate in place, the locating ball on the reversing base is reliably located in the first locating slot of the cover under the affecting of the locating spring to ensure the locating of the reversing base and the retainer and avoid the freely rotating of the retainer. In the same way, when the working mode is needed to be switched, we just need to reverse the reversing base slightly, then the locating ball can overcome the force of the locating spring to move from the first locating slot, and slide along the transition groove to locate in the second locating slot.

Preferably, an adjusting through hole cut through an end of the friction cylinder along the axial direction may be disposed in the end of the joint. An adjusting through hole and an engaging round hole which has a big belly but narrow mouth may be disposed on the outside wall of the joint, wherein the engaging steel ball may be disposed in the engaging round hole coming out from the outside of the engaging steel ball, the adjusting rod removable along the axial direction may be disposed in the adjusting through hole, an adjusting spring may be disposed liner for the adjusting rod, an engaging groove and a releasing groove connecting together in the axial direction may be disposed on the circumference surface of the adjusting rod, a depth of the engaging groove may be less than that of the releasing groove, the adjusting spring may drive the adjusting rod to move to one end of the friction cylinder, at this time, an inside position of the engaging steel ball may be inside the engaging groove of the adjusting rod; when the adjusting rod is pressed to extrude the adjusting spring moving along the axial direction, the engaging steel ball may correspond to the releasing groove, and may be able to move inward to drop into the releasing groove.

As the engaging round hole has a big belly but narrow mouth, the outside of the engaging steel ball can reveal the engaging round hole in a convex shape, but the engaging steel ball cannot be pulled out from the engaging round hole, at this point the inside of the engaging steel ball stuck in the engaging groove of the adjusting rod, and the joint plugged into the connecting hole of the socket can be stuck in the connecting hole of the socket by the convex engaging steel ball, the disengagement between the joint and the socket can be avoided. When we need to insert the joint into the connecting hole of the socket, we can press the adjusting rod to make adjusting rod move in radial direction, at this point the engaging steel ball moves from the engaging groove to the releasing groove with a large depth, and then the joint can be inserted into the connecting hole of the socket, the inner wall of the connecting hole can press the engaging steel ball to make the engaging steel ball move inward to the releasing groove; when the joint is plugged in place, we can loosen the adjusting rod, the adjusting spring drives the adjusting rod to move to the friction cylinder side, then the inside of the engaging steel ball relocates in the engaging groove of the adjusting rod, thus the engaging steel ball juts out from the engaging round hole, and realize the clamping between the joint and the connecting hole of the socket.

Preferably, an countersink co-axial with the adjusting through hole may be disposed in the end of the friction cylinder, an adjusting cap matching with the countersink may be disposed in an end of the adjusting rod on the side near the countersink, and the adjusting spring on the adjusting rod may be disposed in the countersink.

As the adjusting cap is located in the countersink, the adjusting rod has a good guide property, and can induce the area of pressing on the adjusting rod, which helps the performance of the adjusting rod.

Preferably, an inner attaching surface extended along the axial direction may be disposed on the circumference surface of the friction element, wherein the inner attaching surface may be a concave cylindrical surface matching with the circumference surface of the friction cylinder, two outer attaching surfaces intersecting of a V shape may be symmetrically disposed in the opposite side to the inner attaching surface on the circumference surface of the friction element, an intersection of the outer attaching surfaces may be equal to that of the two adjacent outer friction surfaces in the friction cavity.

As the inner attaching surface matching with the circumference surface of the friction cylinder is disposed on the circumference surface of the friction element, therefore, on one hand the free rotating of the friction element and the friction cylinder is achieved, on the other head, the contacting area of the friction element and the friction cylinder is relatively large, which can help to increase the friction force between them and decrease the working pressure of them both.

Preferably, the friction elements may be made of porous metal, oil storage cavities may be disposed in the friction element, and lubricating grease may be disposed in the oil storage cavities.

Porous metal can be made by means of powder metallurgy, and the material is a porous body with pores crossing and cutting through each other. Therefore, when the invention is working for a long time continually and under a large workload, the friction element will emit heat and be locked at the interval between the outer friction surface of the friction cavity and cylindrical surface of the friction cylinder and result in the phenomenon of locking, or the phenomenon of clamping stagnation when the invention is rotated in reverse. Lubricating grease are stored in the friction element in the invention, thus when the friction element emits heat under press, the lubricating grease is heated and the viscosity thereof is decreased, and then the lubricating grease spills over into the outer surface by the small holes of the friction element, and the lubrication of the friction element is achieved to avoid the phenomenon of locking of the friction element.

Therefore, the invention has the following advantages: avoiding the wrench to idle, and observably improving the structural strength of the wrench without increasing the scale of it, which extends its service time effectively.

### BRIEF DESCRIPTION OF THE DRAWINGS

FIG. 1 is an exploded structural schematic diagram of the invention;

FIG. 2 is a partial top view of the invention without the cover;

FIG. 3 is a partial cutaway view of the invention;

FIG. 4 is a cutaway view of the cover;

FIG. 5 is a connecting structural schematic diagram of the friction cylinder and the adjusting rod; and

FIG. 6 is a structural schematic diagram of the friction element.

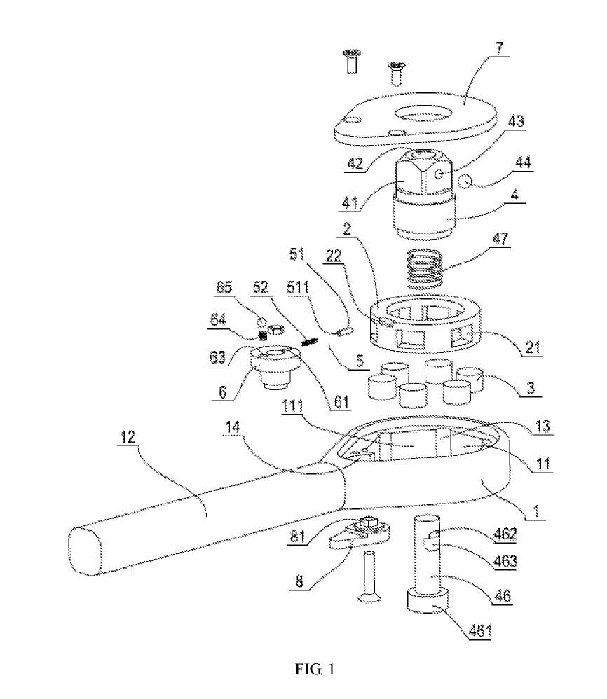

In the figures. 1. outer shell 11. friction cavity 111. outer friction surface 12. handle 13. diffusion groove 14. reversing cavity 2. retainer 21. containing groove 22. locating notch 3. friction element 31. inner attaching surface 32. outer attaching surface 33. oil storage cavity 4. friction cylinder 41. joint 42. adjusting through hole 421. installing straight slot 43. engaging round hole 44. engaging steel ball 45. countersink 46. adjusting rod 461. adjusting cap 462. engaging groove 463. releasing groove 47. adjusting spring 5. toggle element 51. toggle rod 511. spring hole 52. telescopic compression spring 6. reversing base 61. radial engaging slot 62. square hole 63. locating hole 64. locating spring 65. locating ball 7. cover 71. locating slot 72. transition groove 8. toggle handle 81. protruding block

### DETAILED DESCRIPTION OF THE INVENTION

In view of the figures, the technical solution of the invention is described in a manner sufficiently clear and complete.

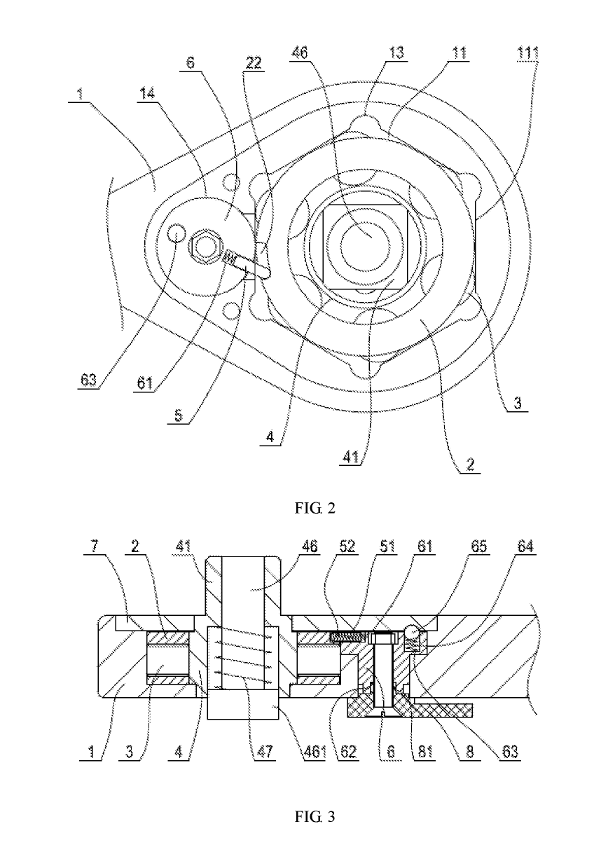

As shown in FIG. 1 and FIG. 2, a friction ratchet wrench is used with an conventional socket, a polygonal socket-connection hole connecting with the nut and the bolt head in one end of the socket, a square connection hole connecting with the wrench in the other end, more especially, the invention comprises an outer shell 1, one end of the outer shell 1 is approximately of circle shape, a friction cavity 11 of regular polygon is disposed in the end surface thereof, in the embodiment, the friction cavity is of regular hexagon, each side of the friction cavity forms an outer friction surface 111. The other end of the outer shell 1 is of a strip, and thus becomes a handled handle 12. A rotated retainer 2 is disposed in the friction cavity, six friction elements 3 with the same amount of the outer friction surfaces of the friction cavity are disposed in the circum of the retainer, and the friction element are uniformly distributed round the centre of the friction cavity in circumferential direction, each friction element locates at the peak angle corresponding to the regular polygon friction cavity.

It's important to notice that for ease of description, in the embodiment, the end with the friction cavity in the outer shell 1 is defined to be the upper end, and the opposite one is defined to be the lower.

In order to facilitate the processing, the retainer can be made of a circle, it has an outer wall and an inner wall, wherein six containing grooves 21 cut through the inner wall of the retainer in the radial direction is disclosed in the outer wall of the retainer, the cross section of the containing groove is of rectangle, and the six containing grooves are uniformly distributed in the circumferential direction. Accordingly, the friction element is of cylinder, the axis of the friction element is parallel to the axis of the retainer, the friction element is disposed one-to-one in the containing groove, and the cross section of the containing groove matches with the longitudinal section of the friction element. In other words, the friction element can rotate in the containing groove and move in radial along the containing groove.

In further, a friction cylinder 4 is needed to be disposed in the inner wall of the retainer, of course, as the axis of the friction cylinder is approximately the same as that of the retainer, a joint 41 of regular square prism integrative extended along the axial direction is disposed in the upper end of the friction cylinder at the same time, so that the squared connecting hole is connected in the socket, and of course the scale of the cross section of the joint should be matched with the connecting hole, and we can disposed a chamfer in edge of the end of the joint in further to insert the joint into the connecting hole easily.

In addition, we need to dispose a toggle element 5 in the outer shell 1 to drive the retainer to rotate in the friction cavity, which presses the outside of the friction element in the retainer close to the outer friction surface of the friction cavity, and the inside of the friction element close to the friction cylinder in the retainer.

The friction ratchet wrench in this invention needs to be used with a conventional socket, when we need to tighten the nut, first we need to toggle the toggle element to make the retainer rotate reversely in the friction cavity, the friction element in the retainer rotate to the place close to the outer friction surface of the friction cavity. As the friction element of the invention is located in the annular cavity formed by the friction cavity of the regular polygon and the cylindrical surface of the friction cylinder, the interval between the friction cavity and the friction cylinder has the maximum value at the peak angle of the corresponding friction cavity and the minimum value at the middle place of the outer friction surface. Therefore, when the toggle element is toggled in place, the friction element is stuck in the interval between the outer friction surface of the friction cavity and the friction cylinder, and friction forces are generated because of the extrusion between the friction element and the friction cylinder and between the friction element and the outer friction surface, therefore the invention is of a forward inactive stat. At this point we can cover the socket on the nut and insert the joint into the connecting hole of the socket, then rotate outer shell 1 forward by the handle, now the friction element has a trend of moving to the side of the minimum interval in the interval between the outer friction surface and the friction cylinder, therefore a friction force is generated between the friction element and the outer friction surface and between the friction element and the friction cylinder, and a self-locking is generated between the friction element and the outer friction surface and between the friction element and the cylindrical surface of the friction cylinder. Therefore, the outer shell 1 can drive the friction cylinder to rotate depending on the friction force between the friction element and the outer friction surface and between the friction element and the friction cylinder, then the socket is driven to rotate forward to tighten the nut through the joint; when the handle drives the outer shell 1 to rotate forward to a certain angle, we can rotate the outer shell 1 in reverse, then the outer shell 1 can drive the friction element to rotate in reverse, therefore the friction element has a trend of moving to the side of the maximum interval in the interval between the outer friction surface and the friction cylinder, thus the friction element slides because of losing the squeezing action between the outer friction surface of the friction cavity and the friction cylinder, which ensures the outer shell 1 freely rotate in the reversed direction; the screw and the nut can be tightened after multiple rotating in both directions of the outer shell 1. Thus, it's understandable that when we need to disassembly the nut, we only need to toggle the toggle element first to make the retainer rotate forward in the friction cavity and in the inactive state of reversed direction, and then we can drive the socket to rotate in reverse and assemble the nut.

Moreover, we can dispose the diffusion groove 13 at the peak angle of the friction cavity in the outer shell 1, the lower side of the diffusion groove extends along the depth direction of the cylindrical surface of the friction cavity, in other words, the two sides of the diffusion groove respectively connect with the outer friction surfaces in the two sides of the peak angle. The diffusion groove can increase the maximum interval at the peak angle of the corresponding friction cavity between the friction cavity and the friction cylinder to facilitate the installing of the retainer and the friction element, meanwhile the stress concentration phenomenon at the intersection of the two neighboring outer friction surfaces can be remitted obviously, it improves the intensity and the service time of the outer shell 1, and facilitates the processing and manufacturing of the outer friction surface of the friction cavity.

It's important to notice that the external diameter of the retainer needs to be preferred to match the distance between the two opposite outer friction surfaces of the friction cavity, thus the retainer can be successfully locate in the friction cavity, when the toggle elements rotate toggle retainer, the six friction elements can generate uniform friction forces.

For the convenience of the rotating of the retainer, we can dispose a cylindrical reversing cavity 14 extending from the top to the bottom in the side of the outer shell 1 close to the friction cavity, a reversing base 6 in the reversing cavity rotatably, and a radial engaging slot 61 cutting through the outer wall and facing the retainer in the reversing base in radial, the toggle element comprises a toggle rod 51 disposed in the radial engaging slot, a locating notch 22 is disposed in the place directly facing to the reversing base in the upper edge of the retainer, the outer end of the toggle rod extended to the radial engaging slot is located in the locating notch. Therefore, when we rotate the reversing base in both directions, the toggle rod cam be driven to swing forward-inverse. In addition, we can also dispose a co-axial spring hole 511 in the inner surface of the radial engaging slot in the toggle rod, which makes the toggle rod in the shape of socket, and a telescopic compression spring 52 is disposed in the spring hole, one end of the telescopic compression spring presses the toggle rod, the other end presses the side surface of the radial engaging slot, and thus the outer end of the toggle rod is driven to tightly press in the locating notch. When we rotate the reversing base to drive the retainer to rotate, the locating notch will rotate along an arcs path, then the toggle rod can overcome the elastic force of the telescopic compression spring and moves back and forth in the radial engaging slot.

As the telescopic compression spring is mainly disposed in the spring hole of the toggle rod, in other words, the telescopic compression spring overlaps most with the toggle rod, which is benefit to an enough length of the toggle rod and the telescopic compression spring, meanwhile the toggle rod can make the telescopic compression spring have a good guide property, and avoid the telescopic compression spring from bending when compressed, which is convenient for its installing. More especially, the telescopic compression spring makes the end of the toggle rod tightly press the locating notch all along, and in further makes the friction element of the retainer has no interval with the outer friction surface and the friction cylinder, which effectively avoids the phenomenon of idling of the invention during work.

It's understandable that we need to dispose a cover 7 in the opening of the outer shell 1 in the friction cavity to locate the structure in the outer shell 1, the cover can be fixed in the outer shell 1 by the screw. Of course, we need to dispose a through-hole in the position corresponding to the friction cylinder in the cover to help the joint go through the through-hole upward, and a locating step adapted to the through-hole is disposed in the joint of the friction cylinder with the joint to obtain a good locating of the friction cylinder.

For the convenience of the rotation of the reversing base, as shown in FIG. 3, we can dispose a square hole 62 in the lower end of the reversing base, a through-hole is disposed in the lower end of the outer shell 1 corresponding to the square hole, and a toggle handle 8 is disposed in the outside of the lower end of the outer shell 1, a protruding block 81 of square is disposed in the toggle handle, the squared protruding block cross the through-hole of the outer shell 1 upward and locate in the square hole of the lower end of the reversing base, so that the reversing base can be rotate by toggling the toggle handle. Of course, we need to dispose a screw through-hole running through to the upper end of the reversing base upward in the lower end of the toggle handle, and dispose an upward countersunk head screw in the screw through-hole, the screw in upper end of the countersunk head screw is in connection with a nut, which connects the toggle handle together with the reversing base.

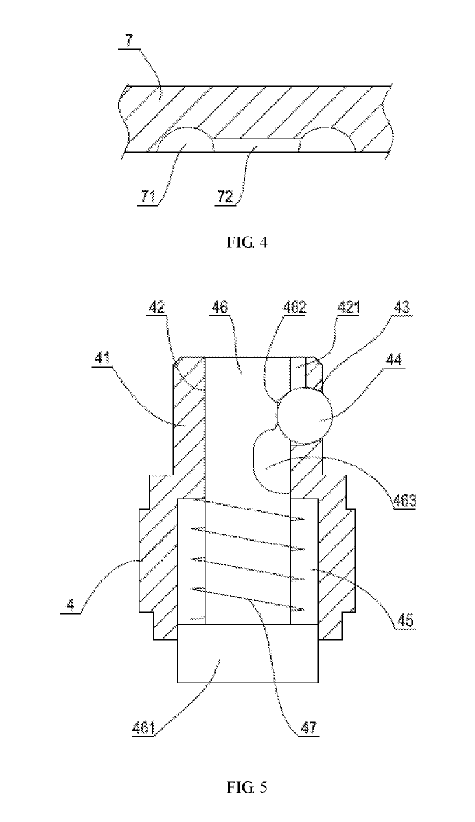

To ensure the toggle element and retainer locate accurately during rotating, we can dispose a axial extended locating hole 63 on the upper surface of one side near the opening of the friction cavity on the reversing base, a locating spring 64 and a locating ball 65 are disposed from inside to outside of the locating hole, as shown in FIG. 4, two locating slots 71 and a cambered transition groove 72 connected the two locating slots are disposed on an inner surface of the cover, the depth of the transition groove is less than that of the locating slot, wherein the locating ball is limited in the first locating slot, at this point the retainer is in mode of deflection, accordingly, the invention is of a forward inactive state. When we need to switch the invention to the reversed inactive state, we can switch the reversing base through the toggle handle and make the locating ball move to the second locating slot along the transition groove.

To ensure the reliable connection between the joint and the socket, as shown in FIG. 5, we can dispose a adjusting through hole 42 cut through the lower end of the friction cylinder in the axial direction in the upper end of the joint, and meanwhile dispose an engaging round hole 43 cut through the adjusting through hole in the radial direction in the outer wall of the joint and an engaging steel ball 44 in the engaging round hole. In addition, the engaging round hole has a big belly but narrow mouth, the diameter of the opening of the engaging round hole is less than that of the engaging steel ball, thus the outside of the engaging steel ball can reveal the engaging round hole, but the engaging steel ball cannot be pulled out from the engaging round hole. More specifically, the engaging round hole can be an inverted conical bore, or the combination of an inverted conical bore and cylindrical hole. In addition, a axially movable adjusting rod 46 is disposed in the adjusting through hole, of course, we can dispose a countersink 45 in co-axial with the adjusting through hole in the lower end of the friction cylinder, and a adjusting cap 461 matching with the countersink in the lower end of the countersink of the adjusting rod. Moreover, an engaging groove 462 and a releasing groove 463 are needed to be disposed in the circumference surface of the upper end of the adjusting rod, the engaging groove and the releasing groove are connected together from top to the bottom in the axial direction of the adjusting rod, and the depth of the engaging groove is less than that of the releasing groove, and an adjusting spring 47 is covered on the adjusting rod, the adjusting spring of the adjusting rod is located in the countersink, therefore the lower end of the adjusting spring presses adjusting cap, and the upper end presses the step between the countersink and the adjusting through hole, the adjusting rod moves to the lower end of the friction cylinder under the effect of the adjusting spring, at this point the inside of the engaging steel ball presses and locates in the engaging groove of the adjusting rod; when we press the adjusting cap of the adjusting rod upward, the adjusting rod moves upward, which makes the engaging steel ball opposite to the releasing groove of deeper depth, the engaging steel ball can move inward to press the releasing groove, which makes the engaging steel ball hide in the engaging round hole completely.

When we need to insert the joint into the connecting hole of the socket, we can press the adjusting cap upward to make the engaging steel ball opposite to the releasing groove of deeper depth, then insert the joint into the connecting hole of the socket, at this point the inner wall of the connecting hole can press the engaging steel ball to make the engaging steel ball press the releasing groove inward, and hides in the engaging round hole completely; when the joint is inserted in place, we can loosen the adjusting rod, and the adjusting spring drive the adjusting rod to reset, at this point the inside of the engaging steel ball is reset to be opposite to the engaging groove with a smaller depth of the adjusting rod, thus the engaging steel ball bulges outside from the engaging round hole, the clamping between the joint and the connecting hole of the socket is realized.

For the convenience of the installing of the adjusting rod, we can dispose a installing straight slot 421 extending downward along the axial direction on the inner wall of the adjusting through hole in the upper end of the joint, the installing straight slot connects with the engaging round hole, and the sum of the depth of the installing straight slot and the depth of the releasing groove should be equal to the diameter of the engaging steel ball, the adjusting rod and the adjusting cap are adopted with fission structure, and connected together by the screw. Therefore, we can dispose and press the engaging steel ball in the releasing groove first, and cover the adjusting spring on the adjusting rod, then insert the adjusting rod into adjusting through hole from top to the bottom, at this point the deeper releasing groove in the adjusting rod is in opposite to the installing straight slot of the joint, therefore, the adjusting rod can move downward in axial direction, the engaging steel ball in the releasing groove moves downward along the installing straight slot; when the engaging steel ball is in opposite to the engaging round hole, the engaging steel ball enters the engaging round hole in radial direction from outside, and the adjusting rod can continually move downward in place, at this time the engaging steel ball presses the shallower engaging groove, after that, we can use a screw to fix the adjusting cap in the lower end of the adjusting rod, and finish the installing of the adjusting rod.

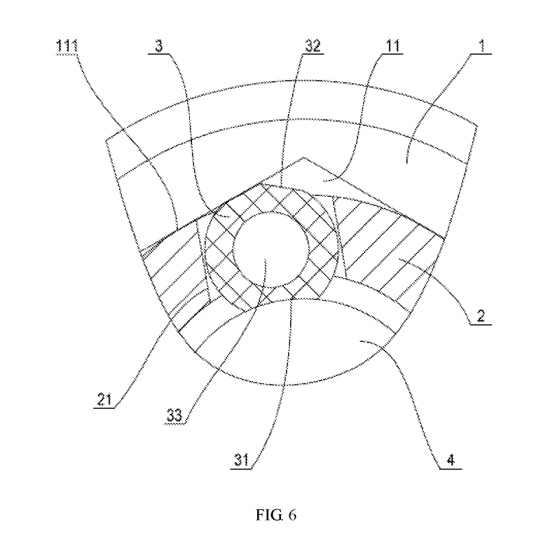

In further, as shown in FIG. 6, we can dispose an inner attaching surface 31 extending along the axial direction in the circumference surface of the cylindrical friction element, wherein the inner attaching surface is a recessed cylindrical surface for matching the circumference surface of the friction cylinder, and two outer attaching surface 32 with an angle in the opposite side to the inner attaching surface on the circumference surface of the friction element symmetrically, the angle of the two outer attaching surfaces is equal to the angle between the two neighboring outer friction surfaces in the or the hexagonal friction cavity, which makes the two outer attaching surfaces in a bulgy V shape. Therefore, when the friction element is disposed in the opposite place of the peak angle of the friction cavity, the friction element is in a loose state, the outer shell 1 cannot transmit the torque to the friction cylinder. When the toggle element and the toggle retainer rotates and locates in a forward or reversed inactive state, the friction element is stuck in the interval between the outer friction surface of the friction cavity and the circumference surface of the friction cylinder, at this point the inner attaching surface of the friction element connects the friction cylinder tightly, and an outer attaching surface of the friction element connects with the outer friction surface of the friction cavity tightly, which makes the contact area of the friction element with the friction cylinder and the friction cavity relatively, and the friction force between them can be added to transmit the torque in need, meanwhile it helps to decrease the pressure of the friction element to the friction cavity and the friction cylinder, and avoid the fovea in the outer friction surface of the friction cavity and the cylindrical surface of the friction cylinder.

At last, the friction element of the invention can be manufactured in molding by means of powder metallurgy to become porous metal with small holes, and an oil storage cavity 33 is disposed in the friction element, and lubricating grease is disposed in the oil storage cavity. As when the invention is working for a long time continually and under a large workload, the friction element emits heat under press, the lubricating grease is heated and the viscosity thereof is decreased, and then the lubricating grease spills over into the outer surface by the small holes of the friction element, and the lubrication of the friction element is achieved to avoid the phenomenon of locking of the friction element.

Although the invention is described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A friction ratchet wrench, suitable for connecting with a socket, the friction ratchet wrench comprising:
an outer shell, having a regular polygonal friction cavity, every side surface of the friction cavity constituting an outer friction surface;
a retainer, rotatablely located inside the friction cavity, wherein friction elements are disposed at periphery of the retainer corresponding to peak angles of the regular polygonal friction cavity;
a friction cylinder, located inside the retainer, wherein a joint integrally extending along an axial direction and capable of being connected with the socket is disposed on the friction cylinder; and
a toggle element, capable of driving the retainer to rotate in the friction cavity, so that outer sides of the friction elements on the retainer are abutted against the outer friction surface of the friction cavity and inner sides of the friction elements are abutted against the friction cylinder located inside the retainer;
wherein when the outer shell rotates in a direction opposite to a rotating direction of the retainer, the outer shell is able to drive the friction cylinder to rotate depending on friction force between the friction elements and the friction force between the friction elements and the friction cylinder, and further to drive the joint to rotate.

2. The friction ratchet wrench according to claim 1, wherein the friction cavity is of regular hexagon, diffusion grooves are disposed at the peak angles of the friction cavity in the outer shell, undersurfaces of the diffusion grooves are cylindrical surfaces extending along a depth direction of the friction cavity, and two sides of the diffusion grooves are connected with the outer friction surfaces on both sides of the peak angles, respectively.

3. The friction ratchet wrench according to claim 1, wherein the retainer is of circular ring, containing grooves are disposed on an outside wall of the retainer, whose quantity is the same as that of the outer friction surfaces of the friction cavity, the containing groove cuts through the inside wall of the retainer along the axial direction and uniformly distributes along the circumference direction, the friction elements are of cylinder, and the axes of the friction elements are in parallel with that of the retainer, each of the friction elements correspondingly disposes in each containing groove, a cross section of the containing groove matches with a longitudinal section of the friction elements.

4. The friction ratchet wrench according to claim 1, wherein a reversing cavity located by the side of the friction cavity is disposed inside the outer shell, and a rotatable reversing base is disposed in the cavity, wherein the toggle element comprises a scalable toggle rod is disposed on the reversing base, a locating notch is disposed on the retainer, an end of the toggle rod is located in the locating notch.

5. The friction ratchet wrench according to claim 4, wherein a radial engaging slot cutting through the outside wall is disposed on the reversing base, the toggle rod is slidingly connected in the radial engaging slot, an outer end of the toggle rod stretched out of the radial engaging slot is located in the locating notch, a spring hole is disposed in an inner end of the toggle rod, and a telescopic compression spring is disposed in the spring hole.

6. The friction ratchet wrench according to claim 4, wherein a locating hole extended along the axial direction is disposed on the upper surface of one side near the opening of the friction cavity on the reversing base, a locating spring and a locating ball are disposed from inside to outside of the locating hole, a cover is disposed at the opening of the friction cavity of the outer shell, two locating slots and a cambered transition groove connected the two locating slots are disposed on an inner surface of the cover, a depth of the transition groove is less than that of the locating slot, wherein the locating ball is limited in the first locating slot, and when reversing base is rotated, the locating ball moves to the second locating slot along the transition groove.

7. The friction ratchet wrench according to claim 1, wherein an adjusting through hole cut through an end of the friction cylinder along the axial direction is disposed in the end of the joint. An adjusting through hole and an engaging round hole which had a big belly but narrow mouth are disposed on the outside wall of the joint, wherein the engaging steel ball is disposed in the engaging round hole coming out from the outside of the engaging steel ball, the adjusting rod removable along the axial direction is disposed in the adjusting through hole, an adjusting spring is disposed liner for the adjusting rod, an engaging groove and a releasing groove connecting together in the axial direction are disposed on the circumference surface of the adjusting rod, a depth of the engaging groove is less than that of the releasing groove, the adjusting spring drives the adjusting rod to move to one end of the friction cylinder, at this time, an inside position of the engaging steel ball is in the engaging groove of the adjusting rod; when the adjusting rod is pressed to extrude the adjusting spring moving along the axial direction, and the engaging steel ball corresponds to the releasing groove and is able to move inward to drop into the releasing groove.

8. The friction ratchet wrench according to claim 7, wherein an countersink co-axial with the adjusting through hole is disposed in the end of the friction cylinder, an adjusting cap matching with the countersink is disposed in an end of the adjusting rod on the side near the countersink, and the adjusting spring on the adjusting rod is disposed in the countersink.

9. The friction ratchet wrench according to claim 1, wherein inner attaching surfaces extending along the axial direction are disposed on circumference surfaces of the friction elements, the inner attaching surfaces are concave cylindrical surfaces matching with circumference surfaces of the friction cylinder, two outer attaching surfaces intersecting of a V shape are symmetrically disposed in the opposite side to the inner attaching surface on the circumference surface of the friction elements, and an intersection of the outer attaching surfaces is equal to that of the two adjacent outer friction surfaces in the friction cavity.

10. The friction ratchet wrench according to claim 1, wherein the friction elements are made of porous metal, oil storage cavities are disposed in the friction elements, and lubricating grease is disposed in the oil storage cavities.

11. The friction ratchet wrench according to claim 2, wherein an adjusting through hole cut through an end of the friction cylinder along the axial direction is disposed in the end of the joint. An adjusting through hole and an engaging round hole which had a big belly but narrow mouth are disposed on the outside wall of the joint, wherein the engaging steel ball is disposed in the engaging round hole coming out from the outside of the engaging steel ball, the adjusting rod removable along the axial direction is disposed in the adjusting through hole, an adjusting spring is disposed liner for the adjusting rod, an engaging groove and a releasing groove connecting together in the axial direction are disposed on the circumference surface of the adjusting rod, a depth of the engaging groove is less than that of the releasing groove, the adjusting spring drives the adjusting rod to move to one end of the friction cylinder, at this time, an inside position of the engaging steel ball is in the engaging groove of the adjusting rod; when the adjusting rod is pressed to extrude the adjusting spring moving along the axial direction, and the engaging steel ball corresponds to the releasing groove and is able to move inward to drop into the releasing groove.

12. The friction ratchet wrench according to claim 3, wherein an adjusting through hole cut through an end of the friction cylinder along the axial direction is disposed in the end of the joint. An adjusting through hole and an engaging round hole which had a big belly but narrow mouth are disposed on the outside wall of the joint, wherein the engaging steel ball is disposed in the engaging round hole coming out from the outside of the engaging steel ball, the adjusting rod removable along the axial direction is disposed in the adjusting through hole, an adjusting spring is disposed liner for the adjusting rod, an engaging groove and a releasing groove connecting together in the axial direction are disposed on the circumference surface of the adjusting rod, a depth of the engaging groove is less than that of the releasing groove, the adjusting spring drives the adjusting rod to move to one end of the friction cylinder, at this time, an inside position of the engaging steel ball is in the engaging groove of the adjusting rod; when the adjusting rod is pressed to extrude the adjusting spring moving along the axial direction, and the engaging steel ball corresponds to the releasing groove and is able to move inward to drop into the releasing groove.

13. The friction ratchet wrench according to claim 4, wherein an adjusting through hole cut through an end of the friction cylinder along the axial direction is disposed in the end of the joint. An adjusting through hole and an engaging round hole which had a big belly but narrow mouth are disposed on the outside wall of the joint, wherein the engaging steel ball is disposed in the engaging round hole coming out from the outside of the engaging steel ball, the adjusting rod removable along the axial direction is disposed in the adjusting through hole, an adjusting spring is disposed liner for the adjusting rod, an engaging groove and a releasing groove connecting together in the axial direction are disposed on the circumference surface of the adjusting rod, a depth of the engaging groove is less than that of the releasing groove, the adjusting spring drives the adjusting rod to move to one end of the friction cylinder, at this time, an inside position of the engaging steel ball is in the engaging groove of the adjusting rod; when the adjusting rod is pressed to extrude the adjusting spring moving along the axial direction, and the engaging steel ball corresponds to the releasing groove and is able to move inward to drop into the releasing groove.

14. The friction ratchet wrench according to claim 5, wherein an adjusting through hole cut through an end of the friction cylinder along the axial direction is disposed in the end of the joint. An adjusting through hole and an engaging round hole which had a big belly but narrow mouth are disposed on the outside wall of the joint, wherein the engaging steel ball is disposed in the engaging round hole coming out from the outside of the engaging steel ball, the adjusting rod removable along the axial direction is disposed in the adjusting through hole, an adjusting spring is disposed liner for the adjusting rod, an engaging groove and a releasing groove connecting together in the axial direction are disposed on the circumference surface of the adjusting rod, a depth of the engaging groove is less than that of the releasing groove, the adjusting spring drives the adjusting rod to move to one end of the friction cylinder, at this time, an inside position of the engaging steel ball is in the engaging groove of the adjusting rod; when the adjusting rod is pressed to extrude the adjusting spring moving along the axial direction, and the engaging steel ball corresponds to the releasing groove and is able to move inward to drop into the releasing groove.

15. The friction ratchet wrench according to claim 2, wherein inner attaching surfaces extending along the axial direction are disposed on circumference surfaces of the friction elements, the inner attaching surfaces are concave cylindrical surfaces matching with circumference surfaces of the friction cylinder, two outer attaching surfaces intersecting of a V shape are symmetrically disposed in the opposite side to the inner attaching surface on the circumference surface of the friction elements, and an intersection of the outer attaching surfaces is equal to that of the two adjacent outer friction surfaces in the friction cavity.

16. The friction ratchet wrench according to claim 3, wherein inner attaching surfaces extending along the axial direction are disposed on circumference surfaces of the friction elements, the inner attaching surfaces are concave cylindrical surfaces matching with circumference surfaces of the friction cylinder, two outer attaching surfaces intersecting of a V shape are symmetrically disposed in the opposite side to the inner attaching surface on the circumference surface of the friction elements, and an intersection of the outer attaching surfaces is equal to that of the two adjacent outer friction surfaces in the friction cavity.

17. The friction ratchet wrench according to claim 4, wherein inner attaching surfaces extending along the axial direction are disposed on circumference surfaces of the friction elements, the inner attaching surfaces are concave cylindrical surfaces matching with circumference surfaces of the friction cylinder, two outer attaching surfaces intersecting of a V shape are symmetrically disposed in the opposite side to the inner attaching surface on the circumference surface of the friction elements, and an intersection of the outer attaching surfaces is equal to that of the two adjacent outer friction surfaces in the friction cavity.

18. The friction ratchet wrench according to claim 5, wherein inner attaching surfaces extending along the axial direction are disposed on circumference surfaces of the friction elements, the inner attaching surfaces are concave cylindrical surfaces matching with circumference surfaces of the friction cylinder, two outer attaching surfaces intersecting of a V shape are symmetrically disposed in the opposite side to the inner attaching surface on the circumference surface of the friction elements, and an intersection of the outer attaching surfaces is equal to that of the two adjacent outer friction surfaces in the friction cavity.

19. The friction ratchet wrench according to claim 6, wherein inner attaching surfaces extending along the axial direction are disposed on circumference surfaces of the friction elements, the inner attaching surfaces are concave cylindrical surfaces matching with circumference surfaces of the friction cylinder, two outer attaching surfaces intersecting of a V shape are symmetrically disposed in the opposite side to the inner attaching surface on the circumference surface of the friction elements, and an intersection of the outer attaching surfaces is equal to that of the two adjacent outer friction surfaces in the friction cavity.

20. The friction ratchet wrench according to claim 2, wherein the friction elements are made of porous metal, oil storage cavities are disposed in the friction elements, and lubricating grease is disposed in the oil storage cavities.
